(19) United States
(12) Patent Application Publication
(10) Pub. No.: US 2025/0380110 A1
(43) Pub. Date: Dec. 11, 2025

(54) MANAGEMENT APPARATUS AND MANAGEMENT METHOD

(71) Applicant: JVCKENWOOD Corporation, Yokohama-shi (JP)

(72) Inventor: Masaomi Fukazawa, Yokohama-shi (JP)

(21) Appl. No.: 19/312,371

(22) Filed: Aug. 28, 2025

Related U.S. Application Data
(63) Continuation of application No. PCT/JP2024/006160, filed on Feb. 21, 2024.

(30) Foreign Application Priority Data
Mar. 3, 2023 (JP) 2023-032394

(51) Int. Cl. H04W 4/021; H04W 4/90

(52) U.S. Cl. CPC H04W 4/021; H04W 4/90

(57) ABSTRACT

A management apparatus includes a communication unit that receives regular information that includes location information that is transmitted from a wireless device at predetermined time intervals, an observation information acquisition unit that acquires, from an external apparatus, observation information that includes an observed danger level that is indicated by an observation result for each of areas, and an instruction unit that transmits control information for designating a time interval for periodical transmission of the regular information to the wireless device via the communication unit based on the observation information and location information on the wireless device.

### CROSS-REFERENCE TO RELATED APPLICATIONS

This application is a Continuation of PCT International Application No. PCT/JP2024/006160 filed on Feb. 21, 2024, which claims the benefit of priority from Japanese Patent Application No. 2023-032394, filed on Mar. 3, 2023, the entire contents of both of which are incorporated herein by reference.

### BACKGROUND OF THE INVENTION

### 1. Field of the Invention

The present disclosure relates to a management apparatus and a management method.

### 2. Description of the Related Art

A technology for allowing a plurality of communication devices that are included in a wireless communication system to periodically transmit current location information to a management apparatus or the like is known. For example, Japanese Laid-open Patent Publication No. 2004-138562 discloses a technology for controlling a frequency of transmission of positioning information in accordance with a danger level at a positioning point of a positioning device.

In the technology disclosed in Japanese Laid-open Patent Publication No. 2004-138562, the frequency of transmission of the positioning information is controlled based on only a fixed danger level that is determined in advance. Therefore, in the technology disclosed in Japanese Laid-open Patent Publication No. 2004-138562, for example, it may be difficult to accurately calculate a danger level in circumstances in which a natural disaster situation or the like keeps changing.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A management apparatus according to the present disclosure comprising: a communication unit that receives regular information that includes location information that is transmitted from a wireless device at predetermined time intervals; an observation information acquisition unit that acquires, from an external apparatus, observation information that includes an observed danger level that is indicated by an observation result for each of areas; and an instruction unit that transmits control information for designating a time interval for periodical transmission of the regular information to the wireless device via the communication unit based on the observation information and location information on the wireless device; and a storage unit that stores therein dangerous area inform, wherein
the instruction unit includes a current danger level calculation unit that calculates a current danger level that indicates a current danger level by adding the area danger level and the observation danger level for each of the areas; and a time interval determination unit that determines a time interval for transmission of the regular information on the wireless device based on the current danger level and the location information on the wireless device.

A management method according to the present disclosure comprising: receiving regular information that includes location information that is transmitted from a wireless device at predetermined time intervals; acquiring, from an external apparatus, observation information that includes an observed danger level that is indicated by an observation result for each of areas; transmitting control information for designating a time interval for periodical transmission of the regular information to the wireless device via the communication unit based on the observation information and location information on the wireless device; storing therein dangerous area inform, wherein calculating a current danger level that indicates a current danger level by adding the area danger level and the observation danger level for each of the areas; and determining a time interval for transmission of the regular information on the wireless device based on the current danger level and the location information on the wireless device.

### BRIEF DESCRIPTION OF THE DRAWINGS

FIG. 1 is a diagram illustrating a configuration example of a communication system according to a first embodiment;

FIG. 2 is a diagram for explaining an overview of the communication system according to the first embodiment;

FIG. 3 is a block diagram illustrating a configuration example of a management apparatus of the first embodiment;

FIG. 4 is a flowchart illustrating the flow of a time interval determination process according to the first embodiment;

FIG. 5 is a diagram illustrating an example of observation information according to the first embodiment;

FIG. 6 is a diagram illustrating an example of dangerous area information according to the first embodiment;

FIG. 7 is a diagram illustrating an example of current danger level information according to the first embodiment;

FIG. 8 is a diagram illustrating a disaster risk area according to the first embodiment;

FIG. 9 is a diagram for explaining a method of identifying a wireless device that is located in a disaster area according to the first embodiment;

FIG. 10 is a block diagram illustrating a configuration example of a management apparatus according to the second embodiment;

FIG. 11 is a diagram illustrating an example of table information according to the second embodiment;

FIG. 12 is a flowchart illustrating the flow of a time interval determination process according to the second embodiment;

FIG. 13 is a diagram for explaining a method of determining a time interval according to the second embodiment;

FIG. 14 is a flowchart illustrating a flow of a time interval determination process according to a third embodiment;

FIG. 15 is a diagram for explaining a method of changing a time interval at which a wireless device transmits location information according to the third embodiment;

FIG. 16 is a flowchart illustrating a flow of a time interval determination process according to a modification of the third embodiment;

FIG. 17 is a diagram for explaining a method of changing a time interval at which location information on a wireless device in a safe area is periodically transmitted according to the modification of the third embodiment;

FIG. 18 is a flowchart illustrating a process of restoring a time interval according to a fourth embodiment; and

FIG. 19 is a diagram for explaining a method of identifying a wireless device for which the time interval is changed according to the fourth embodiment.

### DETAILED DESCRIPTION OF THE PREFERRED EMBODIMENTS

Embodiments of the present disclosure will be described in detail below with reference to the accompanying drawings. The present disclosure is not limited by the embodiments below. In addition, in the embodiments described below, the same components are denoted by the same reference symbols and repeated explanation will be omitted.

### First Embodiment

### Communication System

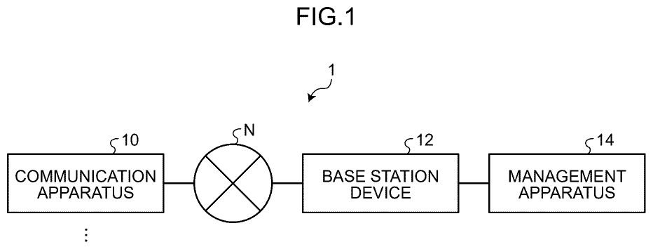

A configuration example of a communication system according to a first embodiment will be described below with reference to FIG. 1. FIG. 1 is a diagram illustrating a configuration example of the communication system according to the first embodiment.

As illustrated in FIG. 1, a communication system 1 includes a plurality of wireless devices 10, a base station device 12, and a management apparatus 14. The plurality of wireless devices 10 and the base station device 12 are communicably connected to one another via a network N.

The wireless devices 10 are communication apparatuses, such as commercial transceivers or smartphones. The wireless devices 10 perform wireless communication with the base station device 12 via the network N. The wireless devices 10 periodically detect current location information based on a Global Navigation Satellite System (GNSS) signal or the like that is provided by a GNSS satellite. The wireless devices 10 periodically transmit the detected current location information to the base station device 12 at predetermined time intervals.

The base station device 12 is a communication apparatus that performs wireless communication with the wireless devices 10 via the network N.

The management apparatus 14 is an apparatus that manages communication of the communication system 1. The management apparatus 14 manages, for example, communication of the base station device 12. For example, the management apparatus 14 controls the base station device 12 and controls communication between the base station device 12 and the wireless devices 10. The management apparatus 14 periodically acquires, for example, the location information on each of the wireless devices 10 via the base station device 12 at predetermined time intervals.

### Overview

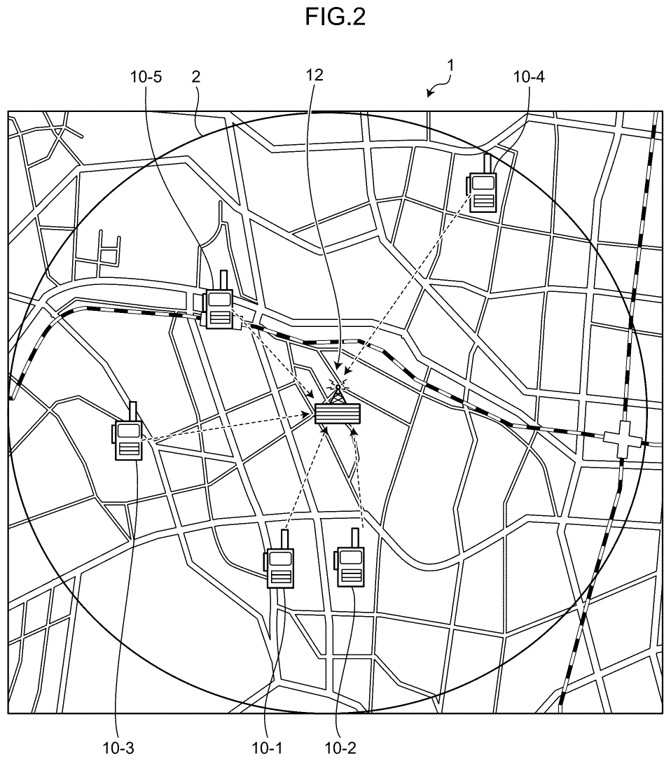

An overview of the communication system according to the first embodiment will be described below with reference to FIG. 2. FIG. 2 is a diagram for explaining an overview of the communication system according to the first embodiment.

As illustrated in FIG. 2, the communication system 1 includes, in a coverage area 2 of the base station device 12 (area in which communication is enabled), a wireless device 10-1, a wireless device 10-2, a wireless device 10-3, a wireless device 10-4, and a wireless device 10-5. Each of the wireless device 10-1 to the wireless device 10-5 periodically transmits current location information to the base station device 12 at predetermined time intervals. A timing at which the wireless device 10-1 to the wireless device 10-5 transmit the location information is designated by the management apparatus 14.

In the present disclosure, the management apparatus 14 calculates a danger level in relation to a natural disaster for each of areas that are included in the coverage area 2. Further, the management apparatus 14 performs a process of changing a time interval at which the wireless device 10-1 to the wireless device 10-5 transmit the location information, in accordance with the danger level of the area.

### Management Apparatus

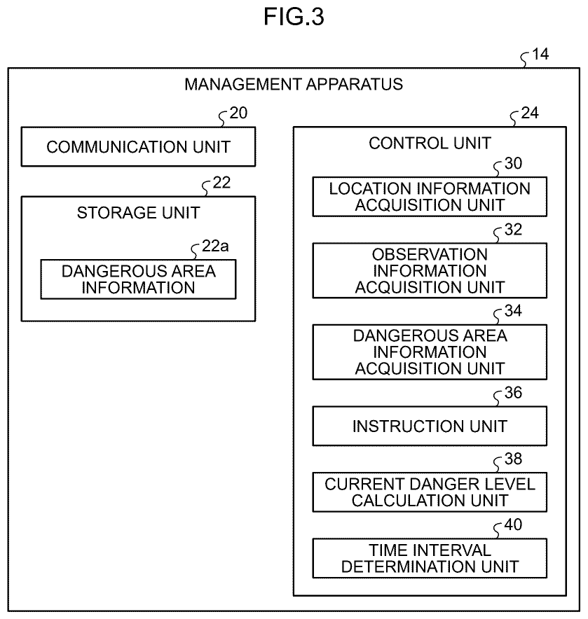

A configuration example of the management apparatus according to the first embodiment will be described below with reference to FIG. 3. FIG. 3 is a block diagram illustrating a configuration example of the management apparatus of the first embodiment.

As illustrated in FIG. 3, the management apparatus 14 includes a communication unit 20, a storage unit 22, and a control unit 24.

The communication unit 20 is a communication interface that implements communication between the management apparatus 14 and an external apparatus. The communication unit 20 implements communication between, for example, the management apparatus 14 and the base station device 12.

The storage unit 22 stores therein various kinds of information. The storage unit 22 stores therein information, such as a detail of calculation performed by the control unit 24 and a program. The storage unit 22 includes, for example, at least one of a main storage device, such as a Random Access Memory (RAM) and a Read Only Memory (ROM), and an external storage device, such as a Hard Disk Drive (HDD).

The storage unit 22 stores therein, for example, dangerous area information 22a. The dangerous area information 22a is information that indicates an area danger level for each of areas. The dangerous area information 22a is, for example, a hazard map that indicates the area danger level for each of specific natural disasters. The hazard map is generated by, for example, a public institution, a private institution, or the like. The hazard map may include, for example, information on a plurality of natural disasters, such as a landslide disaster, a flood disaster, and a tsunami disaster.

The control unit 24 controls each of the units of the management apparatus 14. The control unit 24 includes, for example, an information processing device, such as a Central Processing Unit (CPU) or a Micro Processing Unit (MPU), and a storage device, such as a RAM or a ROM. The control unit 24 may be implemented by, for example, an integrated circuit, such as an Application Specific Integrated Circuit (ASIC) or a Field Programmable Gate Array (FPGA). The control unit 24 may be implemented by a combination of hardware and software.

The control unit 24 includes a location information acquisition unit 30, an observation information acquisition unit 32, a dangerous area information acquisition unit 34, an instruction unit 36, a current danger level calculation unit 38, and a time interval determination unit 40.

The location information acquisition unit 30 acquires the location information on each of the wireless devices 10 via the communication unit 20. The location information acquisition unit 30 periodically acquires the location information on each of the wireless devices 10 at predetermined time intervals via the communication unit 20.

The observation information acquisition unit 32 acquires, from an external apparatus, observation information that includes an observed danger level that is indicated by a natural disaster observation result for each of the areas. Examples of the observation information include locations of rain clouds, a rainfall amount, a snowfall amount, seismic intensity, and a wind speed, but embodiments are not limited to this example. The observation information acquisition unit 32 acquires, from an external apparatus, observation information that is observed by, for example, Japan Meteorological Agency, local government, or the like. The external apparatus is, for example, a server apparatus that is installed in Japan Meteorological Agency, local government, or the like.

The dangerous area information acquisition unit 34 acquires the dangerous area information 22a that is stored in the storage unit 22.

The instruction unit 36 transmits control information for designating a time interval for periodical transmission of the local information, to each of the wireless devices 10 via the communication unit 20. The instruction unit 36 transmits, to each of the wireless devices 10, control information for designating the time interval for periodical transmission of the local information based on, for example, the dangerous area information 22a that is acquired by the dangerous area information acquisition unit 34, the observation information that is acquired by the observation information acquisition unit 32, and the location information on the wireless device 10 that is acquired by the location information acquisition unit 30.

The current danger level calculation unit 38 calculates a current danger level that indicates a current danger level for each of the areas based on the area danger level that is included in the dangerous area information 22a and the observed danger level that is included in the observation information. The current danger level calculation unit 38 identifies, as a disaster risk area, an area in which a disaster is highly likely to occur, based on the calculated current danger level.

When calculating the current danger level, the current danger level calculation unit 38 may correct the observed danger level and calculate the current danger level. For example, even when the observed danger level on the downstream side of a river based on observation information on rain clouds is low, if the observed danger level on the upstream side is high, flood may occur on the downstream side. In this case, the current danger level calculation unit 38 may increase the observed danger level on the downstream side of the river based on the observation information on the rain clouds and then calculate the current danger level.

The time interval determination unit 40 determines the time interval at which the wireless devices 10 periodically transmit the location information, based on the current danger level that is calculated by the current danger level calculation unit 38 and the location information on the wireless device 10 that is acquired by the location information acquisition unit 30.

### Time Interval Determination Process

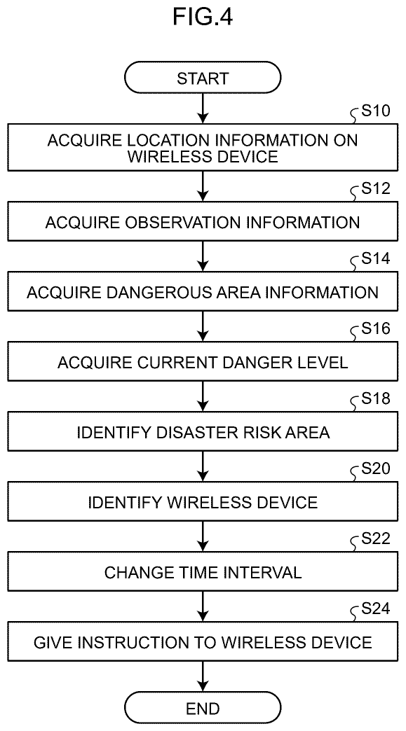

A time interval determination process according to the first embodiment will be described below with reference to FIG. 4. FIG. 4 is a flowchart illustrating the flow of the time interval determination process according to the first embodiment.

FIG. 4 illustrates a process of changing the time interval at which a wireless device that is located in the disaster risk area periodically transmits the location information when, for example, a natural disaster alarm is issued by local government or the like. The process in FIG. 4 is repeated at predetermined periods (for example, 1 minute to 10 minutes) until the alarm is lifted, for example.

The location information acquisition unit 30 acquires the location information on each of the wireless devices 10 (Step S10). Specifically, the location information acquisition unit 30 periodically acquires the location information on each of the wireless devices 10 at predetermined time intervals. Then, the process goes to Step S12.

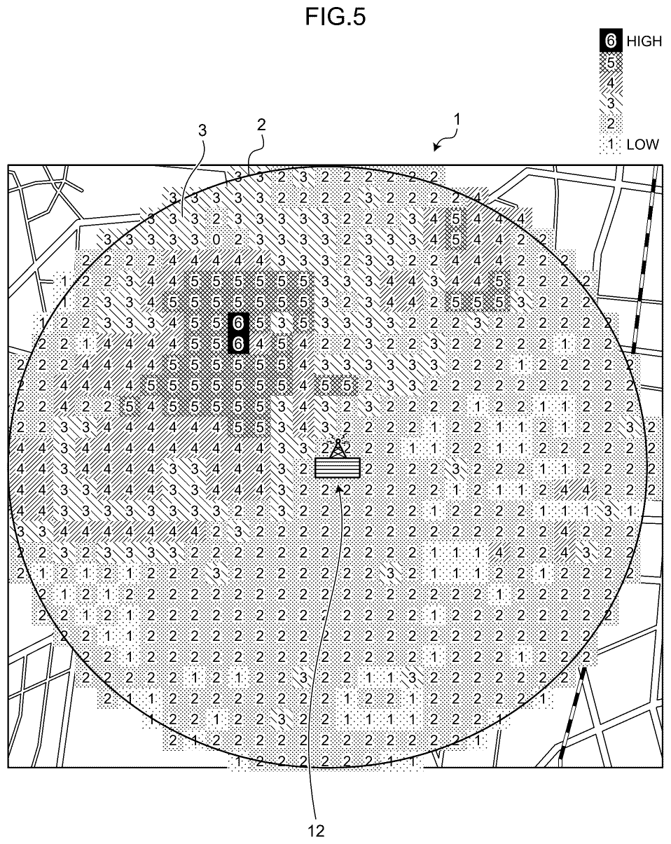

The observation information acquisition unit 32 acquires the observation information from an external apparatus via the communication unit 20 (Step S12). FIG. 5 is a diagram illustrating an example of the observation information according to the first embodiment. FIG. 5 illustrates the observation information on an observation result of rain clouds. As illustrated in FIG. 5, the observation information is provided for each of areas 3 that are meshes into which the coverage area 2 is divided. In FIG. 5, numbers illustrated in the areas 3 indicate the observed danger levels. The observed danger level is indicated on a scale of 1 to 6, such as “1”, “2”, “3”, “4”, “5”, and “6”, for example. In this case, “1” indicates the lowest observed danger level, and “6” indicates the highest observed danger level. Then, the process goes to Step S14.

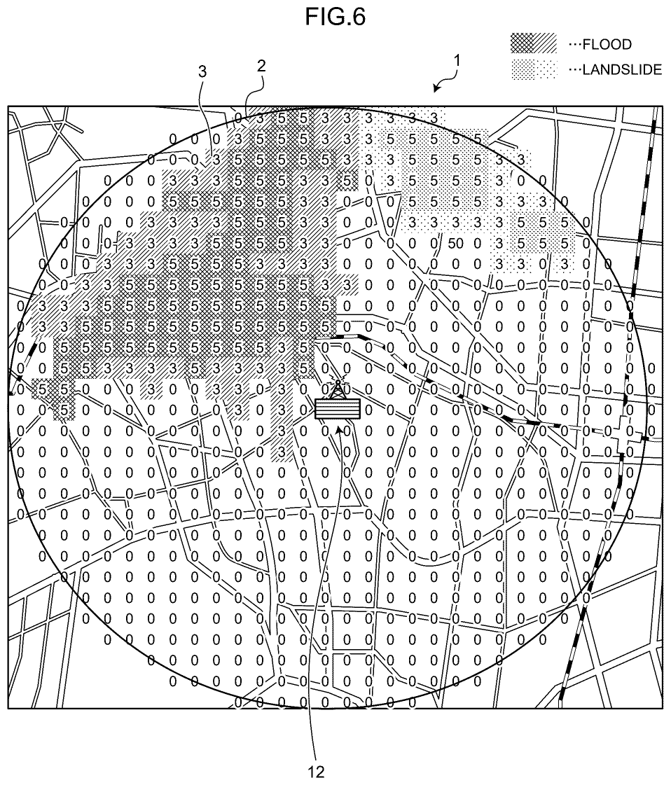

The dangerous area information acquisition unit 34 acquires the dangerous area information 22a that is stored in the storage unit 22 (Step S14). FIG. 6 is a diagram illustrating an example of the dangerous area information according to the first embodiment. As illustrated in FIG. 6, the dangerous area information is provided for each of the areas 3 that are meshes into which the coverage area 2 is divided. In FIG. 6, numbers illustrated in the areas 3 indicate the area danger levels. The area danger level is indicated on a scale of 1 to 6, such as “1”, “2”, “3”, “4”, “5”, and “6”, for example. In this case, “1” indicates the lowest area danger level, and “6” indicates the highest area danger level. In the example illustrated in FIG. 6, the area danger levels related to “flood” and “landslide” are provided. Then, the process goes to Step S16.

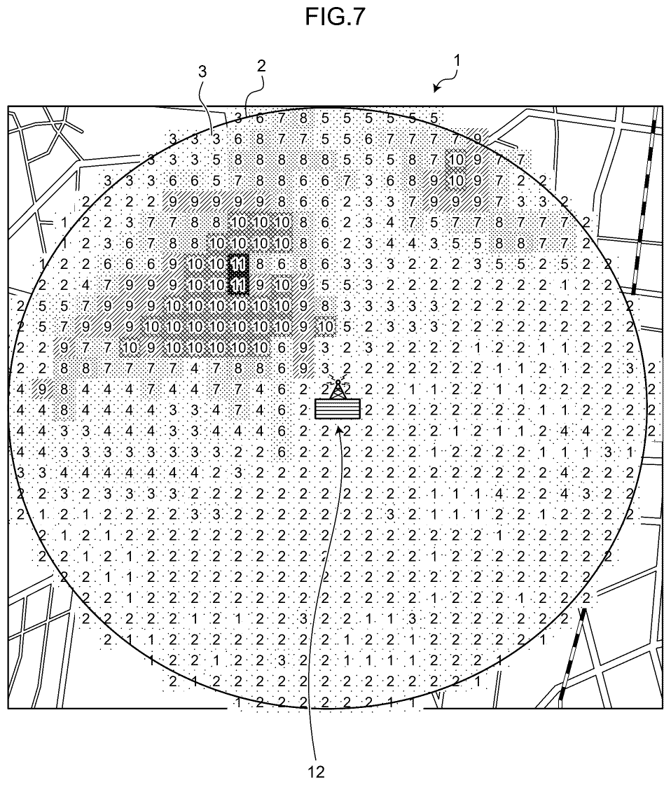

The current danger level calculation unit 38 calculates the current danger level that indicates a current danger level based on the observation information that is acquired by the observation information acquisition unit 32 and the dangerous area information 22a that is acquired by the dangerous area information acquisition unit 34 (Step S16). FIG. 7 is a diagram illustrating an example of current danger level information according to the first embodiment. The current danger level calculation unit 38 calculates the current danger level for each of the areas in the coverage area 2 by, for example, adding up the observed danger level that is indicated by the observation information and the area danger level that is indicated by the dangerous area information 22a. In FIG. 7, numbers illustrated in the areas 3 indicate the current danger levels. Then, the process goes to Step S18.

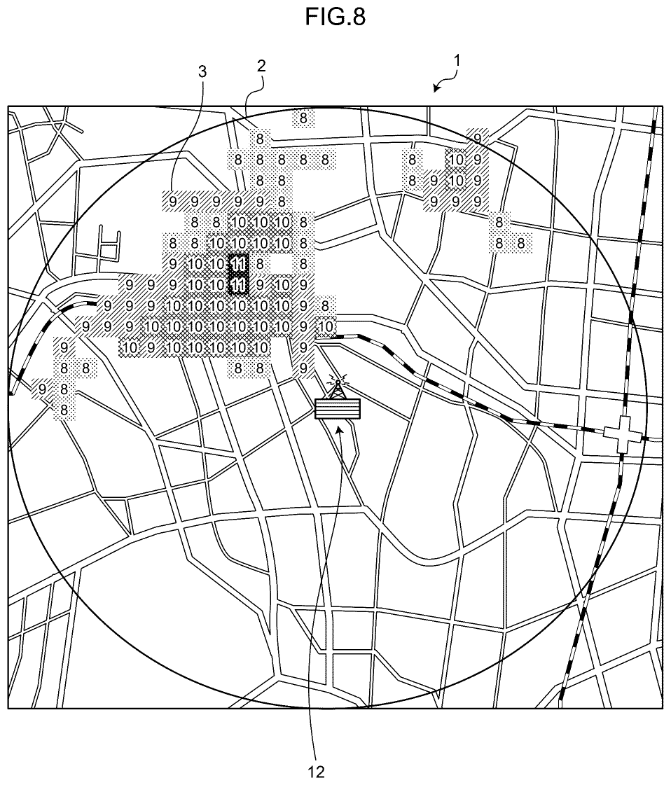

The current danger level calculation unit 38 identifies the disaster risk area based on the calculated current danger level (Step S18). FIG. 8 is a diagram illustrating the disaster risk area according to the first embodiment. The current danger level calculation unit 38 identifies, as the disaster risk area, an area in which the current danger level is equal to or larger than a predetermined number of points, for example. In the example illustrated in FIG. 8, the current danger level calculation unit 38 identifies, as the disaster risk area, an area in which the current danger level is equal to or larger than eight among the plurality of areas 3 in the coverage area 2. Then, the process goes to Step S20.

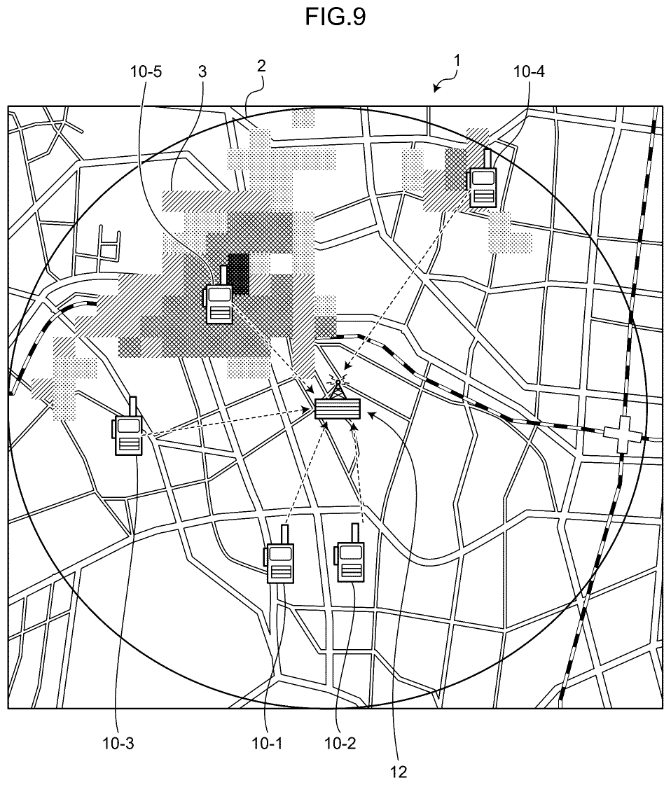

The location information acquisition unit 30 identifies the wireless device 10 that is located in the disaster risk area in the coverage area 2 (Step S20). FIG. 9 is a diagram for explaining a method of identifying the wireless device that is located in a disaster area according to the first embodiment. The location information acquisition unit 30 identifies the wireless device 10 that is located in the disaster risk area based on the location information on each of the wireless devices 10 and the disaster risk area. In the example illustrated in FIG. 9, the location information acquisition unit 30 identifies the wireless device 10-4 and the wireless device 10-5 as the wireless devices 10 that are located in the disaster risk area. Then, the process goes to Step S22.

The time interval determination unit 40 determines the time interval at which the wireless device 10 that is located in the disaster risk area periodically transmits the location information (Step S22). Specifically, when a normal time interval is 120 seconds, the time interval determination unit 40 determines the time interval as 5 seconds. Then, the process goes to Step S24.

The instruction unit 36 instructs the wireless device 10 that is located in the disaster risk area to change the time interval via the communication unit 20 (Step S24). Specifically, in the example illustrated in FIG. 9, the instruction unit 36 transmits control information for changing the time interval from 120 seconds to 5 seconds to the wireless device 10-4 and the wireless device 10-5 via the communication unit 20. Accordingly, the wireless device 10-4 and the wireless device 10-5 change timings of periodically transmitting the location information to the base station device 12 from 120 seconds to 5 seconds. Then, the process in FIG. 4 is terminated.

As described above, according to the first embodiment, it is possible to reduce the time interval at which the wireless device 10 that is located in the disaster risk area periodically transmits the location information. With this configuration, according to the first embodiment, discrepancy between the location information that is received by the base station device 12 and the location information on the wireless device 10 is reduced, so that it is possible to easily find the user of the wireless device 10 when the user is to be rescued.

### Second Embodiment

A second embodiment will be described. In the first embodiment, the example has been described in which the time interval for periodical transmission of the location information on the wireless device 10 that is located in the disaster risk area is reduced. In the second embodiment, a process of changing a time interval at which the wireless device 10 that is not located in the disaster risk area, nor in a safe area periodically transmits the location information is performed.

### Management Apparatus

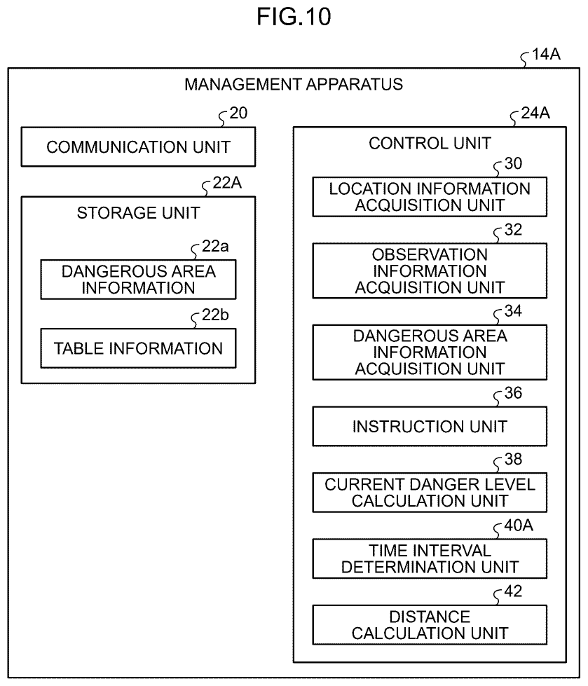

A configuration example of a management apparatus according to the second embodiment will be described below with reference to FIG. 10. FIG. 10 is a block diagram illustrating a configuration example of the management apparatus according to the second embodiment.

As illustrated in FIG. 10, a management apparatus 14A is different from the management apparatus 14 illustrated in FIG. 3 in that a storage unit 22A stores therein table information 22b, and a control unit 24A includes a distance calculation unit 42.

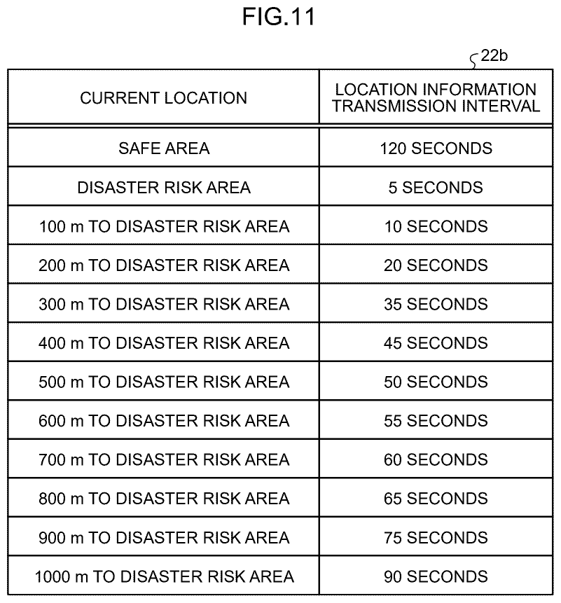

FIG. 11 is a diagram illustrating an example of the table information according to the second embodiment. As illustrated in FIG. 11, the table information 22b includes items such as “current location” and a “location information transmission interval”. The table information 22b is information that is used to determine the time interval at which the wireless device 10 periodically transmits the location information.

The “current location” indicates a distance from the disaster risk area to the wireless device 10. In the “current location”, an area that is 1000 meters (m) or more away from the disaster risk area is adopted as a safe area.

The “location information transmission interval” indicates the time interval for periodical transmission of the location information. When the current location of the wireless device 10 is in the safe area, the location information transmission interval is, for example, 120 seconds. When the current location of the wireless device 10 is in the disaster risk area, the location information transmission interval is, for example, 5 seconds. When the current location of the wireless device 10 is less than 100 m away from the disaster risk area, the location information transmission interval is 10 seconds. When the current location of the wireless device 10 is equal to or more than 100 m and less than 200 m away from the disaster risk area, the location information transmission interval is 20 seconds. When the current location of the wireless device 10 is equal to or more than 200 m and less than 300 m away from the disaster risk area, the location information transmission interval is, for example, 35 seconds. When the current location of the wireless device 10 is equal to or more than 300 m and less than 400 m away from the disaster risk area, the location information transmission interval is, for example, 45 seconds. When the current location of the wireless device 10 is equal to or more than 400 m and less than 500 m away from the disaster risk area, the location information transmission interval is, for example, 50 seconds. When the current location of the wireless device 10 is equal to or more than 500 m and less than 600 m away from the disaster risk area, the location information transmission interval is, for example, 55 seconds. When the current location of the wireless device 10 is equal to or more than 600 m and less than 700 m away from the disaster risk area, the location information transmission interval is, for example, 60 seconds. When the current location of the wireless device 10 is equal to or more than 700 m and less than 800 m away from the disaster risk area, the location information transmission interval is, for example, 65 seconds. When the current location of the wireless device 10 is equal to or more than 800 m and less than 900 m away from the disaster risk area, the location information transmission interval is, for example, 75 seconds. When the current location of the wireless device 10 is equal to or more than 900 m and less than 1000 m away from the disaster risk area, the location information transmission interval is, for example, 90 seconds.

The distance calculation unit 42 calculates a distance from the disaster risk area to each of the wireless devices 10. The distance calculation unit 42 calculates the distance from the disaster risk area to each of the wireless devices 10 based on, for example, the location information on each of the wireless devices 10 that is acquired by the location information acquisition unit 30.

A time interval determination unit 40A determines the time interval at which each of the wireless devices 10 periodically transmits the location information, based on the distance from the disaster risk area to each of the wireless devices 10 that is calculated by the distance calculation unit 42. The time interval determination unit 40A determines the time interval at which the wireless device 10 periodically transmits the location information based on, for example, the table information 22b.

### Time Interval Determination Process

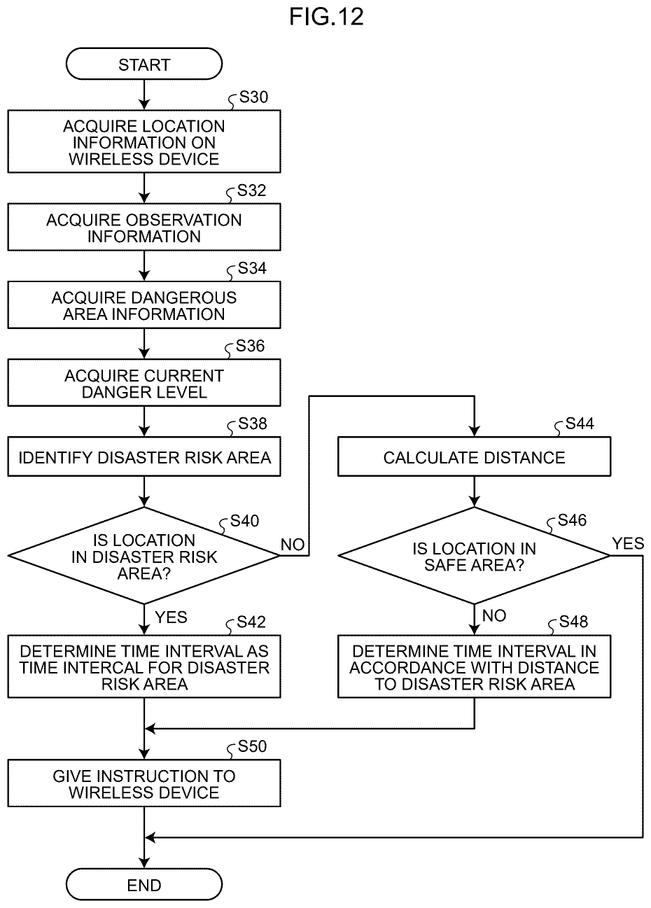

A time interval determination process according to the second embodiment will be described below with reference to FIG. 12. FIG. 12 is a flowchart illustrating the flow of the time interval determination process according to the second embodiment.

FIG. 12 illustrates a process of changing the time interval of periodical transmission of the location information on the wireless device that is located in the disaster risk area when, for example, a natural disaster alarm is issued by local government or the like. The process in FIG. 12 is repeated at predetermined periods (for example, 1 minute to 10 minutes) until the alarm is lifted, for example.

Processes from Step S30 to Step S38 are the same as the processes from Step S10 to Step S18 illustrated in FIG. 4, and therefore, explanation thereof will be omitted.

The location information acquisition unit 30 determines whether or not the current location of the wireless device 10 is in the disaster risk area, based on the location information that is acquired from the wireless device 10 (Step S40). When it is determined that the current location of the wireless device 10 is in the disaster risk area (Step S40; Yes), the process goes to Step S42. When it is not determined that the current location of the wireless device 10 is in the disaster risk area (Step S40; No), the process goes to Step S44.

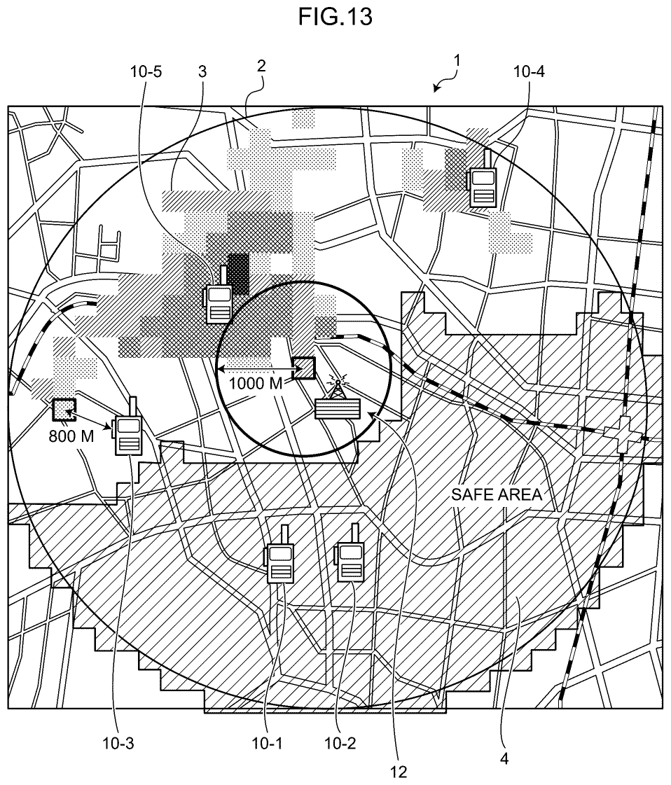

When it is determined as Yes at Step S40, the time interval determination unit 40A determines the time interval at which the wireless device 10 that is located in the disaster risk area transmits the location information as 5 seconds, based on the table information 22b (Step S42). FIG. 13 is a diagram for explaining a method of determining the time interval according to the second embodiment. In the example illustrated in FIG. 13, the wireless device 10-4 and the wireless device 10-5 are located in the disaster risk area. In FIG. 13, a place that is 1000 m or more away from the disaster risk area is a safe area 4. In this case, the time interval determination unit 40A determines the time interval at which the wireless device 10-4 and the wireless device 10-5 transmit the location information as 5 seconds, based on the table information 22b. Then, the process goes to Step S50.

When it is determined No at Step S40, the distance calculation unit 42 calculates the distance from the disaster risk area to each of the wireless devices 10 (Step S44). Specifically, the distance calculation unit 42 calculates a distance to the closest disaster risk area in the coverage area 2 for each of the wireless devices 10. Then, the process goes to Step S46.

The location information acquisition unit 30 determines whether or not the current location of the wireless device 10 is in the safe area based on the distance that is calculated by the distance calculation unit 42 (Step S46). Specifically, when the current location is in the place that is 1000 m or more away from the disaster risk area, the location information acquisition unit 30 determines that the current location of the wireless device 10 is in the safe area. In the example illustrated in FIG. 13, the wireless device 10-1 and the wireless device 10-2 are located in the safe area 4. When it is determined that the current location of the wireless device 10 is in the safe area (Step S46; Yes), the process in FIG. 12 is terminated. Specifically, in the example illustrated in FIG. 13, the time interval at which the wireless device 10-1 and the wireless device 10-2 periodically transmit the location information is not changed. When it is not determined that the current location of the wireless device 10 is in the safe area (Step S46; No), the process goes to Step S48.

When it is determined No at Step S46, the time interval determination unit 40A determines the time interval at which the wireless device 10 transmits the location information, in accordance with the distance to the disaster risk area based on the table information 22b (Step S48). In the example illustrated in FIG. 13, the wireless device 10-3 is not located in the disaster risk area and the safe area 4. It is assumed that the distance from the wireless device 10-3 to the disaster risk area is calculated to be equal to or more than 700 m and less than 800 m. In this case, the time interval determination unit 40A sets the time interval at which the wireless device 10-3 periodically transmits the location information to 65 seconds. Then, the process goes to Step S50.

A process at Step S50 is the same as the process at Step S24 illustrated in FIG. 4, and therefore, explanation thereof will be omitted.

As described above, in the second embodiment, with respect to the wireless device 10 that is not located in the safe area, it is possible to reduce the time interval at which the wireless device 10 periodically transmits the location information in accordance with the distance to the disaster risk area. With this configuration, in the second embodiment, discrepancy between the location information that is received by the base station device 12 and the location information on each of the wireless devices 10 is reduced, so that it is possible to easily find the user of each of the wireless devices 10 when the user is to be rescued.

### Third Embodiment

A third embodiment will be described. A configuration of a management apparatus according to the third embodiment is the same as the management apparatus 14A illustrated in FIG. 10, and therefore, explanation thereof will be omitted.

In the third embodiment, it may be possible to dynamically change the time interval at which each of the wireless devices 10 transmits the location information, at a timing at which the location information on each of the wireless devices 10 is acquired. Specifically, in the third embodiment, after an instruction to change the time interval for transmission of the location information on each of the wireless devices 10 is issued, if the location information on each of the wireless devices 10 is changed, the time interval at which each of the wireless devices 10 transmits the location information is further changed.

### Time Interval Change Process

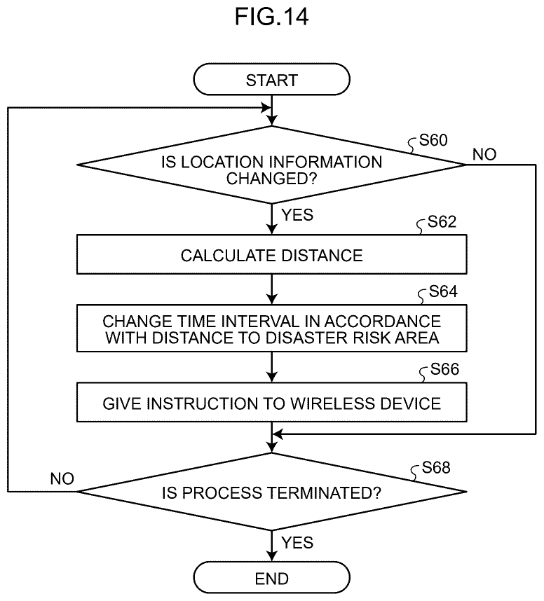

A time interval change process according to the third embodiment will be described below with reference to FIG. 14. FIG. 14 is a flowchart illustrating the flow of the time interval change process according to the third embodiment.

The process illustrated in FIG. 14 is a process that is performed after the time interval determination process illustrated in FIG. 12, for example.

The location information acquisition unit 30 determines whether or not the location information on the wireless device 10 is changed (Step S60). Specifically, the location information acquisition unit 30 determines whether or not the current location of the wireless device 10 is changed, based on the location information that has been previously acquired from the wireless device 10 and the location information that is currently acquired from the wireless device 10. When it is determined that the location information on the wireless device 10 is changed (Step S60; Yes), the process goes to Step S62. When it is not determined that the location information on the wireless device 10 is changed (Step S60; No), the process goes to Step S68.

A process at Step S62 is the same as the process at Step S44 illustrated in FIG. 12, and therefore, explanation thereof will be omitted.

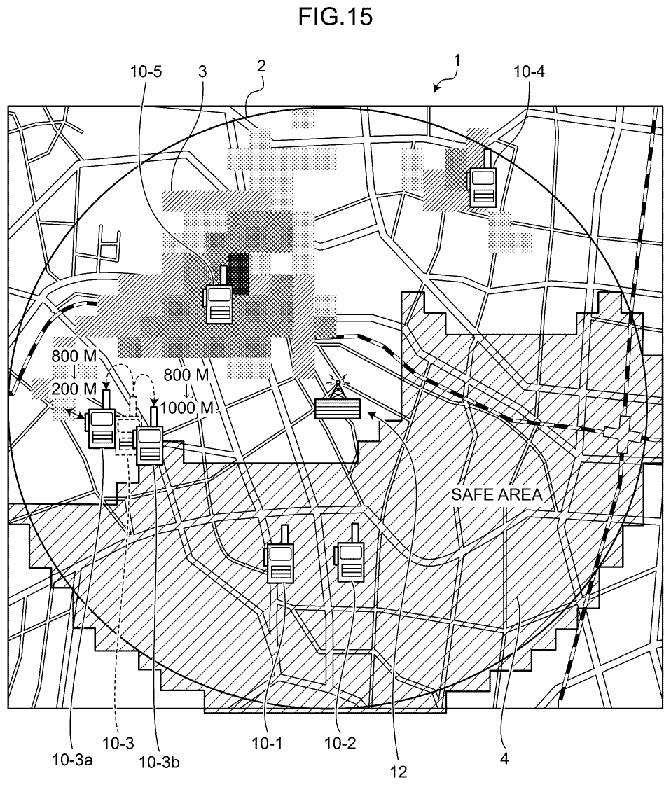

The time interval determination unit 40A changes the time interval at which the wireless device 10 transmits the location information, in accordance with the distance to the disaster risk area based on the table information 22b (Step S64). FIG. 15 is a diagram for explaining a method of changing the time interval at which the wireless device transmits the location information according to the third embodiment. As illustrated in FIG. 15, for example, it is assumed that the wireless device 10-3 has moved from a location that is 800 m away from the disaster risk area to a location that is about 200 m away from the disaster risk area as represented by a wireless device 10-3a. In this case, the time interval determination unit 40A changes the time interval at which the wireless device 10-3 periodically transmits the location information from 65 seconds to 20 seconds based on the table information 22b. For example, it is assumed that the wireless device 10-3 has moved from the location that is 800 m away from the disaster risk area to a location that is about 1000 m away from the disaster risk area as represented by a wireless device 10-3b. In this case, the time interval determination unit 40A changes the time interval at which the wireless device 10-3 periodically transmits the location information from 65 seconds to 90 seconds based on the table information 22b. Then, the process goes to Step S66.

A process at Step S66 is the same as the process at Step S50 illustrated in FIG. 12, and therefore, explanation thereof will be omitted.

The control unit 24A determines whether or not the process in FIG. 14 is terminated (Step S68). Specifically, for example, when the disaster risk area in the coverage area 2 is cancelled, the control unit 24A determines that the process in FIG. 14 is terminated. When it is determined that the process is terminated (Step S68; Yes), the process in FIG. 14 is terminated. When it is not determined that the process is terminated (Step S68; No), the process goes to Step S60.

As described above, in the third embodiment, by comparing the previous location information and the latest location information on the wireless device 10, it is possible to change the time interval at which the wireless device 10 periodically transmits the location information when the location is changed. With this configuration, in the third embodiment, when the wireless device 10 approaches the disaster risk area, a danger level at which the user is affected by a disaster increases, so that it is possible to reduce the time interval at which the wireless device 10 periodically transmits the location information. Furthermore, in the third embodiment, when the wireless device 10 moves away from the disaster risk area, the danger level at which the user is affected by a disaster decreases, so that it is possible to reduce the time interval at which the wireless device 10 periodically transmits the location information. With this configuration, in the third embodiment, it is possible to appropriately change the time interval at which the wireless device 10 periodically transmits the location information.

### Modification of Third Embodiment

A modification of the third embodiment will be described below. In the third embodiment, the previous location information and the latest location information on the wireless device 10 are compared, and when the location is changed, the time interval at which the wireless device 10 periodically transmits the location information is changed. In this case, in the modification of the third embodiment, it may be possible to further increase the time interval at which the wireless device 10 that is located in the safe area periodically transmits the location information, in accordance with the number of the wireless devices 10 that are located in the disaster risk area. Specifically, in the modification of the third embodiment, by reducing the frequency at which the wireless device 10 that is located in the safe area transmits the location information, usage of a communication bandwidth over the entire communication system 1 is maintained constant so as to prevent disturbance of transmission of the location information from the wireless device 10 in the disaster risk area.

### Time Interval Change Process

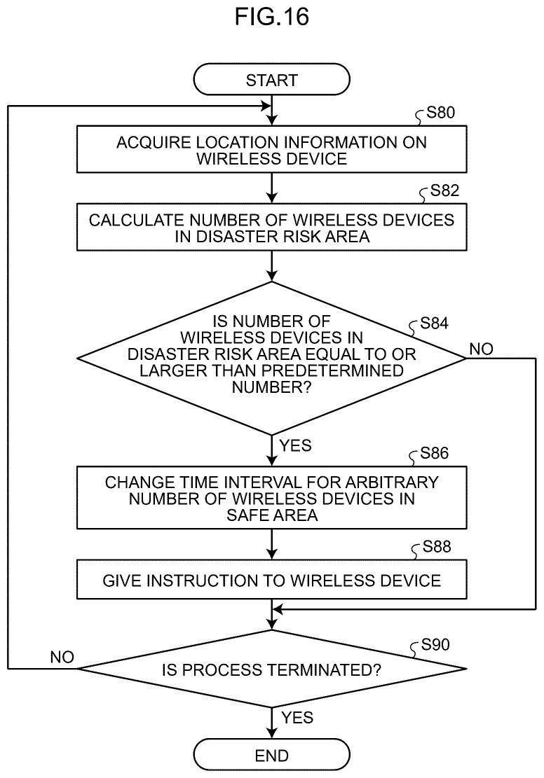

A time interval change process according to the modification of the third embodiment will be described below with reference to FIG. 16. FIG. 16 is a flowchart illustrating the flow of the time interval change process according to the modification of the third embodiment.

FIG. 16 illustrates a process of changing the time interval of periodical transmission of the local information on the wireless device that is located in the disaster risk area when, for example, a natural disaster alarm is issued by local government or the like. The process in FIG. 16 is repeated at predetermined periods (for example, 1 minute to 10 minutes) until the alarm is lifted, for example.

A process at Step S80 is the same as the process at Step S10 illustrated in FIG. 4, and therefore, explanation thereof will be omitted.

The location information acquisition unit 30 calculates the number of the wireless devices 10 that are located in the disaster risk area based on the acquired location information on the wireless devices 10 (Step S82). Then, the process goes to Step S84.

The location information acquisition unit 30 determines whether or not the number of the wireless devices 10 in the disaster risk area is equal to or larger than a predetermined number (Step S84). For example, when one hundred of the wireless devices 10 among one thousand of the wireless devices 10 are located in the disaster risk area, the location information acquisition unit 30 determines that the predetermined number or more of the wireless devices 10 are located in the disaster risk area, but embodiments are not limited to this example. When it is determined that the number of the wireless devices 10 in the disaster risk area is equal to or larger than the predetermined number (Step S84; Yes), the process goes to Step S86. When it is not determined that the number of the wireless devices 10 in the disaster risk area is equal to or larger than the predetermined number (Step S84; No), the process goes to Step S90.

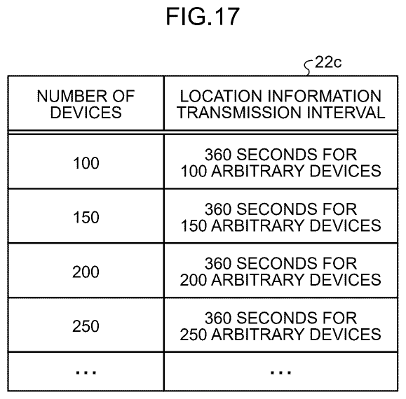

The time interval determination unit 40A changes the time interval at which an arbitrary number of the wireless devices 10 in the safe area periodically transmit the location information (Step S86). FIG. 17 is a diagram for explaining a method of changing the time interval for periodical transmission of the location information on the wireless devices in the safe area according to the modification of the third embodiment. As illustrated in FIG. 17, table information 22c includes items such as “number of devices” and a “location information transmission interval”.

The “number of devices” indicates the number of the wireless devices 10 that are located in the disaster risk area. The “location information transmission interval” indicates a time interval at which the wireless devices 10 that are located in the safe area periodically transmit the location information.

The time interval determination unit 40A changes the time interval for periodical transmission of the location information on the arbitrary wireless devices 10 in the safe area, in accordance with the number of the wireless devices 10 that are located in the disaster risk area based on the table information 22c, for example. When, for example, the number of the wireless devices 10 that are located in the disaster risk area reaches 100, the time interval determination unit 40A changes the time interval for periodical transmission of the location information on the 100 wireless devices 10 that are arbitrarily selected from among the wireless devices 10 that are located in the safe area to 360 seconds. When, for example, the number of the wireless devices 10 that are located in the disaster risk area reaches 150, the time interval determination unit 40A changes the time interval for periodical transmission of the location information on the 150 wireless devices 10 that are arbitrarily selected from among the wireless devices 10 that are located in the safe area to 360 seconds. When, for example, the number of the wireless devices 10 that are located in the disaster risk area reaches 200, the time interval determination unit 40A changes the time interval for periodical transmission of the location information on the 200 wireless devices 10 that are arbitrarily selected from among the wireless devices 10 that are located in the safe area to 360 seconds. When, for example, the number of the wireless devices 10 that are located in the disaster risk area reaches 250, the time interval determination unit 40A changes the time interval for periodical transmission of the location information on the 250 wireless devices 10 that are arbitrarily selected from among the wireless devices 10 that are located in the safe area to 360 seconds. Then, the process goes to Step S88.

A process at Step S88 is the same as the process at Step S50 illustrated in FIG. 12, and therefore, explanation thereof will be omitted. A process at Step S90 is the same as the process at Step S68 illustrated in FIG. 14, and therefore, explanation thereof will be omitted.

As described above, according to the modification of the third embodiment, when the number of the wireless devices 10 that are located in the disaster risk area increases, the time interval for periodical transmission of the local information on the wireless device 10 that is located in the safe area is increased. With this configuration, according to the modification of the third embodiment, it is possible to maintain bandwidth usage of the entire communication system 1 by reducing the frequency at which the wireless device 10 that is located in the safe area transmits the location information, so that it is possible to prevent disturbance of transmission of the location information from the wireless device 10 in the disaster risk area. In the modification of the third embodiment, the time interval for periodical transmission of the location information on the wireless device 10 that is located in the safe area is changed based on the number of the wireless devices 10 that are located in the disaster risk area, but it may be possible to change the time interval for periodical transmission of the local information based on a ratio between the number of devices in the disaster risk area and the number of devices in the safe area. With this configuration, it is possible to maintain a communication amount of the entire communication system.

### Fourth Embodiment

A fourth embodiment will be described. A configuration of a management apparatus according to the fourth embodiment is the same as the management apparatus 14 illustrated in FIG. 3 or the management apparatus 14A illustrated in FIG. 10, and therefore, explanation thereof will be omitted.

In the fourth embodiment, when the disaster risk area in the coverage area 2 is cancelled, a process of restoring a time interval is performed with respect to the wireless device 10 for which the time interval for periodical transmission of the local information has been changed.

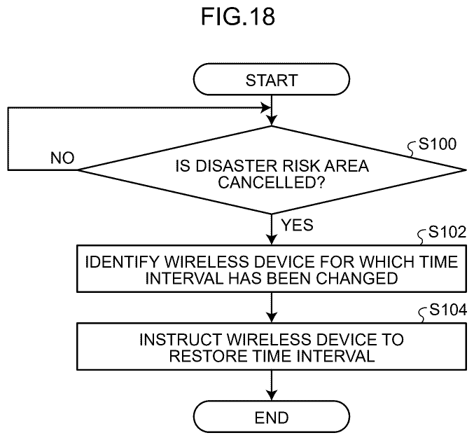

A process of restoring the time interval according to the fourth embodiment will be described below with reference to FIG. 18. FIG. 18 is a flowchart illustrating the process of restoring the original time interval according to the fourth embodiment.

The current danger level calculation unit 38 determines whether or not the disaster risk area in the coverage area 2 is cancelled (Step S100). Specifically, the current danger level calculation unit 38 determines whether or not the disaster risk area in the coverage area 2 is cancelled based on the observation information that is acquired by the observation information acquisition unit 32 and the dangerous area information 22a that is acquired by the dangerous area information acquisition unit 34. When it is determined that the disaster risk area in the coverage area 2 is cancelled (Step S100; Yes), the process goes to Step S102. When it is not determined that the disaster risk area in the coverage area 2 is cancelled (Step S100; No), the process at Step S100 is repeated.

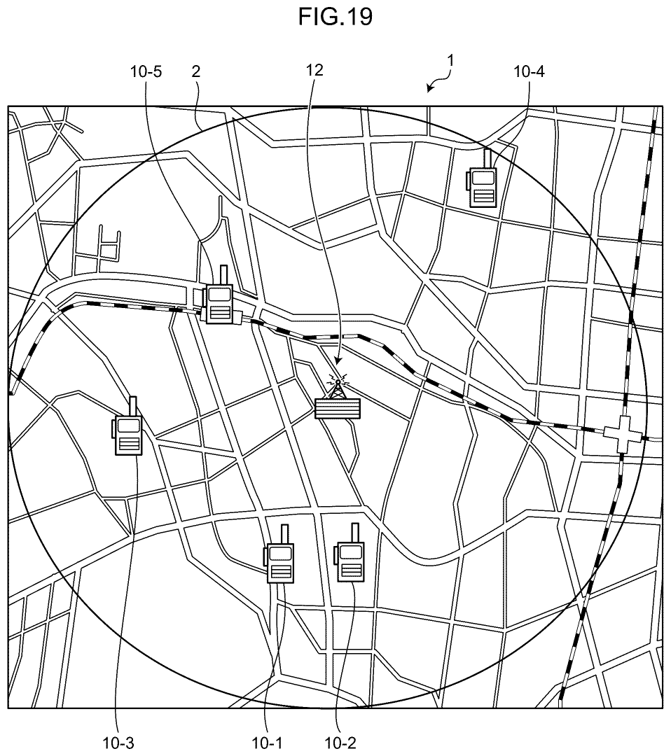

The location information acquisition unit 30 identifies the wireless device 10 for which the time interval for periodical transmission of the transmission information has been changed (Step S102). FIG. 19 is a diagram for explaining a method of identifying the wireless device for which the time interval has been changed according to the fourth embodiment. As illustrated in FIG. 19, the location information acquisition unit 30 identifies the wireless device 10-3, the wireless device 10-4, and the wireless device 10-5 that are located in the disaster risk area in the coverage area 2 as the wireless device 10 for which the time interval for periodical transmission of the transmission information has been changed. Then, the process goes to Step S104.

The instruction unit 36 instructs the wireless device 10 that is located in the disaster risk area to restore the time interval, via the communication unit 20 (Step S104). Specifically, in the example illustrated in FIG. 19, the instruction unit 36 transmits control information for restoring the time interval to the wireless device 10-3, the wireless device 10-4, and the wireless device 10-5 via the communication unit 20. With this configuration, the timing at which the wireless device 10-3, the wireless device 10-4, and the wireless device 10-5 periodically transmits the location information to the base station device 12 is restored to 120 seconds. Then, the process in FIG. 18 is terminated.

As described above, according to the fourth embodiment, when the disaster risk area in the coverage area 2 is cancelled, it is possible to restore the time interval at which each of the wireless devices 10 periodically transmits the local information. With this configuration, according to the fourth embodiment, it is possible to promptly return to normal operation when the disaster risk area is cancelled.

The components of the apparatuses illustrated in the drawings are functionally conceptual, and do not necessarily be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions. Furthermore, the distribution and integration may be dynamically performed.

According to the present disclosure, it is possible to appropriately acquire the location information on the wireless device in accordance with a danger level of an area.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A management apparatus comprising:
a communication unit that receives regular information that includes location information that is transmitted from a wireless device at predetermined time intervals;
an observation information acquisition unit that acquires, from an external apparatus, observation information that includes an observed danger level that is indicated by an observation result for each of areas; and
an instruction unit that transmits control information for designating a time interval for periodical transmission of the regular information to the wireless device via the communication unit based on the observation information and location information on the wireless device; and
a storage unit that stores therein dangerous area inform, wherein
the instruction unit includes
a current danger level calculation unit that calculates a current danger level that indicates a current danger level by adding the area danger level and the observation danger level for each of the areas; and
a time interval determination unit that determines a time interval for transmission of the regular information on the wireless device based on the current danger level and the location information on the wireless device.

2. The management apparatus according to claim 1, wherein when the area in which the current danger level that is calculated by the current danger level calculation unit is equal to or larger than a predetermined threshold is present, the time interval determination unit reduces the time interval for transmission of the regular information with increase in the current danger level at a location of the wireless device, and increases the time interval for transmission of the regular information with decrease in the current danger level at the location of the wireless device.

3. The management apparatus according to claim 1, wherein the time interval determination unit determines the regular information so that the communication bandwidth usage of all wireless devices is maintained at a constant, and the time interval for transmission of the regular information based on number of the wireless devices that are located in the area in which the current danger level that is calculated by the current danger level calculation unit is high and number of the wireless devices that are located in the area in which the current danger level is low.

4. A management method comprising:
receiving regular information that includes location information that is transmitted from a wireless device at predetermined time intervals;
acquiring, from an external apparatus, observation information that includes an observed danger level that is indicated by an observation result for each of areas;
transmitting control information for designating a time interval for periodical transmission of the regular information to the wireless device via the communication unit based on the observation information and location information on the wireless device;
storing therein dangerous area inform, wherein
calculating a current danger level that indicates a current danger level by adding the area danger level and the observation danger level for each of the areas; and
determining a time interval for transmission of the regular information on the wireless device based on the current danger level and the location information on the wireless device.
